(19) United States
(12) Patent Application Publication
(10) Pub. No.: US 2026/0252374 A1
(43) Pub. Date: Aug. 27, 2026

(54) Management of Intelligent Agents in a Workspace

(71) Applicant: Oracle International Corporation, Redwood Shores, CA (US)

(72) Inventors: Yahor Pushkin, Redmond, WA (US); Dan Roth, Philadelphia, PA (US); Federico Torreti, Kenmore, WA (US); Sujith Ravi, Menlo Park, CA (US); Jigar Mody, Redmond, WA (US)

(73) Assignee: Oracle International Corporation, Redwood Shores, CA (US)

(21) Appl. No.: 19/225,633

(22) Filed: Jun. 2, 2025

Related U.S. Application Data
(60) Provisional application No. 63/761,256, filed on Feb. 21, 2025.

(51) Int. Cl. G06F 9/455; H04L 67/562

(52) U.S. Cl. CPC G06F 9/45558; H04L 67/562; G06F 2009/45562; G06F 2009/45583

(57) ABSTRACT

Techniques for managing intelligent agents in an agent workspace are provided. A system executes an agent management platform that facilitates the selection and deployment of agents. A workspace that includes a sandboxed execution environment is created by the system. The system configures the workspace by storing access parameters that are used to access a resource. Agents are deployed into the workspace. The system advertises access parameters within the workspace, which are used to configure agents to access a resource.

### INCORPORATION BY REFERENCE; DISCLAIMER

Each of the following applications are hereby incorporated by reference: Application no. 63/761,256 filed on Feb. 21, 2025. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to intelligent agents (e.g., generative artificial intelligence (AI) agents). In particular, the present disclosure relates to agent workspaces.

### BACKGROUND

In computing, workspaces provide a way to organize and isolate tasks, resources, and user activity within a digital environment. Used by software developers, data analysts, and others, a workspace typically represents a dedicated area that holds files, tools, settings, and context relevant to a particular goal or project. A workspace structure helps reduce clutter, manage complexity, and make it easier to switch between different activities without losing progress or configuration. In cloud systems and collaborative platforms, workspaces also help separate user activity, protect data boundaries, and provide a flexible framework for scaling resources on demand.

Workspaces have become increasingly useful as systems grow in size and complexity. Rather than forcing users or processes to operate in a shared, global environment, workspaces allow tasks or sessions to remain logically separate. This improves reliability, supports parallel work, and makes systems more adaptable to different use cases. In environments that involve automation, testing, development, or data processing, workspaces allow temporary or experimental work to take place without affecting production systems. As computing environments become more dynamic and distributed, workspaces offer a consistent model for managing isolation, access, and lifecycle across users and systems.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an agent workspace and marketplace management system in accordance with one or more embodiments;

FIG. 2 illustrates an example set of operations for an agent workspace in accordance with one or more embodiments;

FIG. 3 illustrates an example set of operations for an agent workspace in accordance with one or more embodiments;

FIG. 4 illustrates an example set of operations for an agent workspace in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. AGENT WORKSPACE ARCHITECTURE
3. MANAGING AGENTS IN A WORKSPACE
4. EXAMPLE EMBODIMENT A
5. EXAMPLE EMBODIMENT B
6. COMPUTER NETWORKS AND CLOUD NETWORKS
7. MICROSERVICE APPLICATIONS
8. HARDWARE OVERVIEW
9. MISCELLANEOUS; EXTENSIONS

### 1. GENERAL OVERVIEW

A workspace is a self-contained computing environment that includes its own runtime context, configuration, and execution scope. This environment may include dedicated memory, process space, environment variables, mounted storage, and access credentials. The runtime isolation allows processes within the workspace to run independently from other parts of the system without sharing execution state, dependencies, or environment settings. This structure helps prevent conflicts between tasks, supports reproducibility, and allows for targeted control over resources and permissions. Workspaces with separate runtime environments are used in cloud platforms, development sandboxes, automated testing pipelines, and remote execution frameworks, where isolation and repeatability are necessary for reliability and scalability.

One or more embodiments execute an agent management platform that facilitates the selection and deployment of agents. A workspace that includes a sandboxed execution environment is instantiated by the system. The system then configures the workspace by storing access parameters corresponding to resources. One or more agents are deployed into the workspace. The system advertises, within the workspace, access parameters that may be used to access a resource. Using these access parameters, the system configures the agent to access the resource.

One or more embodiments described in this Specification and/or recited in the claims may not be included in this General Overview section.

### 2. AGENT WORKSPACE ARCHITECTURE

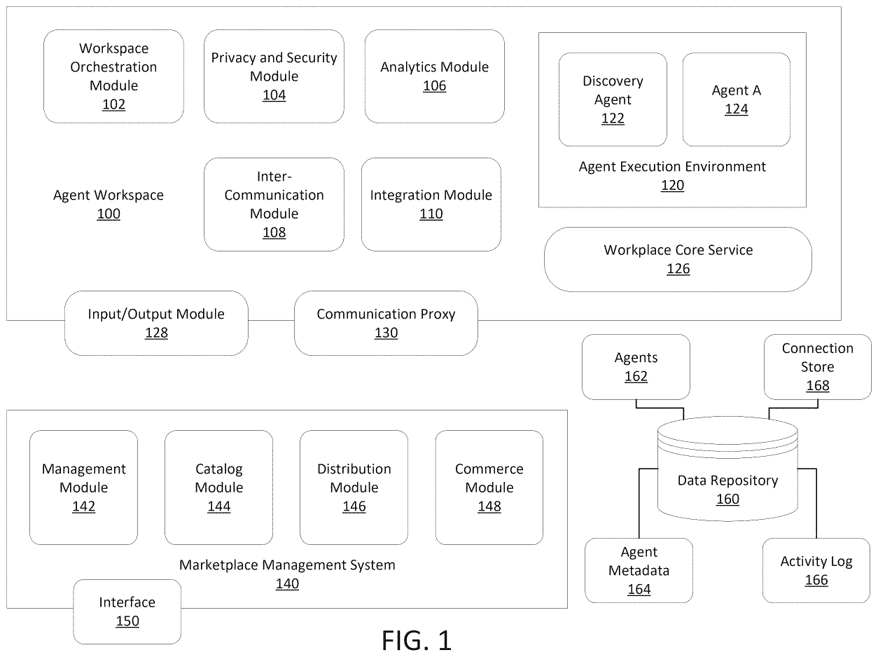

FIG. 1 illustrates an agent workspace 100 and marketplace management system 140 in accordance with one or more embodiments. As illustrated in FIG. 1, agent workspace 100 includes workspace orchestration module 102, privacy and security module 104, analytics module 106, inter-communication module 108, integration module 110, agent execution environment 120, workspace core service 126, input/output module 128, and communication proxy 130. Agent execution environment 120 includes discovery agent 122 and agent A 124. FIG. 1 also illustrates marketplace management system 140, which includes management module 142, catalog module 144, distribution module 146, commerce module 148, and interface 150. FIG. 1 further illustrates data repository 160, which includes agents 162, agent metadata 164, activity logs 166, and connection store 168.

In an embodiment, marketplace management system 140 serves as system for managing an agent marketplace for distributing, discovering, and managing intelligent agents for workforce automation. The marketplace may store information about these agents, or the agents themselves, in data repository 160. Agents selected from the agent marketplace may be deployed in an agent workspace such as agent workspace 100 as part of a workforce automation flow. Agent workspace provides a unified operational environment for agent execution, user-agent interaction, and multi-agent collaboration. An agent authoring and execution environment for the creation, development, and deployment of intelligent agents may be part of agent workspace 100.

In accordance with one or more embodiments, agent workspace 100 is configured to support instantiation, coordination, and termination of agent processes across dynamic execution environments. Agent workspace 100 facilitates data transmission between concurrently executing agents, maps agent identities to logical communication channels, and manages protocol negotiation. When agents communicate between multiple execution environments, agent workspace 100 initiates configuration requests using APIs exposed by inter-communication module 108. These communication bridges are associated with security profiles obtained from privacy and security module 104 and applied during runtime by input/output module 128.

In accordance with one or more embodiments, agent workspace 100 aggregates operational metrics and runtime artifacts for delivery to analytics module 106. Metrics include CPU cycles, memory pressure thresholds, task duration summaries, and I/O throughput. Agent workspace 100 performs in-memory aggregation of time series data and transmits compressed summaries at configurable intervals or upon completion of agent execution. These summaries are timestamped using time references from workspace core service 126 to maintain temporal alignment across components. Agent workspace 100 may receive anomaly detection feedback from analytics module 106 and use the feedback to change future agent deployment strategies.

In accordance with one or more embodiments, workspace orchestration module 102 is configured to manage the lifecycle, execution flow, and resource allocation of agents within agent workspace 100. Workspace orchestration module 102 also facilitates the generation of new workspaces if needed. Workspace orchestration module 102 comprises execution planners, task dependency resolvers, and environment binding engines that operate on task definitions and agent profiles. Workspace orchestration module 102 receives workload information that defines agent behaviors, resource needs, and task sequencing information. The workload information is parsed to identify agent instantiation points, interdependencies, and required execution environment characteristics. Workspace orchestration module 102 initiates agent initiation by transmitting instructions and associated metadata to agent workspace 100 and execution environment 120.

In accordance with one or more embodiments, workspace orchestration module 102 tracks the lifecycle state of agent processes and coordinates reallocation or termination activities in response to system conditions. Agent states, such as initializing, running, suspended, failed, and terminated, are stored in internal state tables. Workspace orchestration module 102 may reassign stalled or underperforming agents by deallocating associated resources and issuing new launch instructions with adjusted parameters. In coordination with integration module 110 and privacy and security module 104, workspace orchestration module 102 validates that reassignments conform to system constraints. State transitions are logged and propagated to workspace core service 126 for persistent storage.

In accordance with one or more embodiments, workspace orchestration module 102 determines agent placement and resource allocation strategies based on real-time metrics and predefined policies. These strategies are derived in part from resource utilization data collected by analytics module 106. Workspace orchestration module 102 determines optimal resource assignments and invokes execution environment 120 to allocate the compute instances with appropriate configurations. Feedback loops between workspace orchestration module 102 and other modules allow dynamic adjustment of execution flow in response to changing runtime conditions.

In accordance with one or more embodiments, privacy and security module 104 is configured to enforce fine-grained access controls, data usage restrictions, and compliance constraints across agent operations. Privacy and security module 104 comprises a policy evaluation engine, a cryptographic key vault, and a secure session token issuer that interoperate with execution paths involving sensitive data. Access policies are derived from workspace-wide configuration manifests or injected during runtime from integration module 110. Privacy and security module 104 maps these policies to specific agent classes or environment contexts and embeds enforcement hooks into execution plans processed by workspace orchestration module 102. These enforcement routines validate agent operations during execution and reject or redact unauthorized actions.

In accordance with one or more embodiments, privacy and security module 104 transmits policy artifacts and enforcement configurations to input/output module 128 and inter-communication module 108 to support secure data transport. Privacy and security module 104 applies encryption requirements and data sanitization rules to outbound content, tagging egress metadata with compliance flags. These tags are referenced during transmission setup to ensure that only authorized recipients receive content that conforms to policy constraints. Privacy and security module 104 also records a trace of policy enforcement decisions in a ledger accessible by analytics module 106. This audit data supports forensic analysis and allows dynamic policy tuning based on usage patterns.

In accordance with one or more embodiments, privacy and security module 104 receives authentication events, anomaly alerts, and other signals from analytics module 106 to adapt runtime policies. Behavior deviation metrics are processed and used to flag agents or sessions for additional scrutiny. Privacy and security module 104 may respond by injecting authentication challenges, limiting data access, or isolating execution containers using reconfiguration requests sent to execution environment 120. Configuration state is shared with agent workspace 100 and workspace orchestration module 102 to coordinate enforcement across modules. Privacy and security module 104 may also invoke external compliance services via integration module 110 to verify legal or contractual constraints.

In accordance with one or more embodiments, analytics module 106 is configured to collect, aggregate, and analyze execution data generated by agents within agent workspace 100. Analytics module 106 comprises data ingestion pipelines, metric normalization processors, and anomaly detection subsystems. Time-stamped events, system resource consumption, inter-agent communication logs, and task completion indicators are received by the analytics module 106 via streaming interfaces or batch transfers. Analytics module 106 associates these data points with session and agent identifiers for traceability across execution environments. Processed metrics are stored in a database that supports performance analysis and operational tuning.

In accordance with one or more embodiments, analytics module 106 generates performance profiles that describe behavior signatures for agents and uses these profiles to recommend adjustments in future task assignments. The recommendations are delivered in structured format and consumed directly by the task scheduler component of workspace orchestration module 102. These adjustments are reflected in subsequent task graph re-compilations.

In accordance with one or more embodiments, inter-communication module 108 is configured to facilitate communication between agents and system modules both within execution environment 120 and across separate isolated execution environments. Inter-communication module 108 comprises transport layer abstraction handlers, message routing engines, and protocol adaptation modules. Logical channel identifiers are mapped to physical transport endpoints based on configuration data received from workspace orchestration module 102 and workspace core service 126. Inter-communication module 108 also registers endpoint availability states and maintains session-level encryption contexts in coordination with privacy and security module 104. Messages are queued, serialized, and transmitted according to connection durability settings and channel priority levels.

In accordance with one or more embodiments, inter-communication module 108 negotiates session capabilities, data encoding formats, and retry semantics during channel initialization. Protocol handshakes may involve exchanging metadata headers, verifying encryption parameters, and establishing message sequence boundaries. Inter-communication module 108 interacts with input/output module 128 to transmit external-bound traffic through system gateways. Delays or failures are logged in the communication metadata store, and retry logic is triggered according to policy-defined backoff intervals. Channel metrics and error indicators are forwarded to analytics module 106 for correlation and visualization.

In accordance with one or more embodiments, inter-communication module 108 processes dynamic channel lifecycle events in response to agent migration, environment reconfiguration, or task reassignment. Teardown procedures are triggered when agent sessions terminate or when communication violations are detected by privacy and security module 104. Inter-communication module 108 logs transitions and synchronization events for replay and recovery operations. These logs may be queried by workspace orchestration module 102 during error recovery or rollback processes.

In accordance with one or more embodiments, integration module 110 is configured to manage external service bindings and adapt internal system outputs to match third-party interface specifications. Integration module 110 comprises API compatibility engines, schema transformers, and credential injection logic that operate in coordination with privacy and security module 104. Request payloads are transmitted via input/output module 128 or routed through inter-communication module 108, depending on the interface type. Integration module 110 also tracks interface usage patterns and reports deviations to analytics module 106.

In accordance with one or more embodiments, integration module 110 defines endpoint URIs, authentication types, version constraints, and preferred encoding schemes. Integration module 110 resolves service identifiers to concrete bindings and stores active connection states in a session registry for reuse across multiple agent executions. When external service policies change, integration module 110 initiates revalidation procedures and updates binding metadata accordingly. These updates are shared with workspace orchestration module 102 to maintain compatibility across agent invocations.

In accordance with one or more embodiments, execution environment 120 is configured to instantiate runtime containers, virtual machines, or sandboxed processes for hosting agents provisioned by agent workspace 100. Execution environment 120 comprises an image loader, environment provisioner, and container scheduler that receive configuration payloads and resource definitions from workspace orchestration module 102. Resource requests specify memory quotas, CPU limits, network isolation parameters, and storage bindings. Execution environment 120 parses the requests and interfaces with host-level virtualization systems to create isolated execution contexts. Environment state is reported back to agent workspace 100 upon successful initialization or failure.

In accordance with one or more embodiments, execution environment 120 manages execution lifecycle events, such as suspension, resumption, and termination of containers. These transitions are triggered by workspace orchestration module 102 or privacy and security module 104 in response to policy changes or system events. Execution environment 120 records environment metadata, agent process identifiers, and resource utilization metrics in structured logs. These logs are transmitted to analytics module 106 and may be used to derive capacity planning models or fault impact assessments. Execution environment 120 may also expose control signals to inter-communication module 108 to coordinate channel updates during migration.

In accordance with one or more embodiments, execution environment 120 receives system-level configuration templates and image references from integration module 110 and workspace core service 126. These templates define the baseline system configuration, installed dependencies, and access permissions required for agent execution. Execution environment 120 caches image layers to reduce deployment latency for frequently used environments. Template validation and compatibility checks are performed prior to launch, and mismatches are reported to workspace orchestration module 102.

In accordance with one or more embodiments, workspace core service 126 is configured to support foundational services required across modules, including identity management, configuration dissemination, and time coordination. Workspace core service 126 comprises a configuration store, identity resolution service, and time synchronization protocol engine. Agent workspace 100, workspace orchestration module 102, and execution environment 120 rely on identifiers and policy anchors retrieved from workspace core service 126 during initialization. Workspace core service 126 resolves names to resource identifiers and returns access constraints that are later enforced by privacy and security module 104. Time synchronization references are used by analytics module 106 to correlate event timelines across distributed components.

In accordance with one or more embodiments, workspace core service 126 interacts with input/output module 128 and integration module 110 to broadcast system health indicators and policy versioning updates. These updates are distributed using internal messaging and tracked using propagation status identifiers. Workspace core service 126 may store propagation summaries for review by system administrators or analysis by analytics module 106.

In accordance with one or more embodiments, workspace core service 126 receives module registration events, execution summaries, and policy enforcement reports from participating components. The received data is stored in structured logs or forwarded to analytics module 106 for processing. Workspace core service 126 serves as the source of record for system topology, module identity, and operational capabilities. During failover events or system upgrades, workspace core service 126 provides the authoritative configuration baseline for recovery operations. These records may also be used by privacy and security module 104 when verifying policy compliance for audit purposes.

In accordance with one or more embodiments, input/output module 128 is configured to manage ingress and egress of data packets between agent processes and external endpoints. Input/output module 128 comprises packet handlers, serialization modules, and connection state trackers that reference session configurations received from workspace orchestration module 102. Input/output module 128 applies transformation rules, header enrichment, and stream segmentation logic before transmission. Interface bindings received from integration module 110 are used to construct outbound requests and validate incoming content formats. Authentication wrappers and token injection routines are applied when configured by privacy and security module 104.

In an embodiment, communication proxy 130 is configured to receive connection requests from agents that specify a target service type and optionally comprise additional agent metadata such as agent metadata 164. Communication proxy 130 parses the request parameters to extract relevant information and determine connection requirements. Communication proxy 130 accesses a configuration store 168 that maps service types to connection profiles. Connection profiles comprise data identifying one or more service endpoints, credential references, and allowed protocols. Communication proxy 130 selects a connection profile based on policy resolution logic that may reference tenant-level constraints or current system load.

In an embodiment, communication proxy 130 uses the selected connection profile to initiate a connection to target service via interface 150. Communication proxy 130 generates transport-specific headers based on the original request and the retrieved connection profile, inserting authentication tokens, client identity information, and protocol-specific flags into the outbound request when necessary. Communication proxy 130 maintains a mapping between the original request and the resolved connection to support response routing, logging, and governance requirements. Communication proxy 130 optionally performs connection pooling by associating persistent transport-layer connections with identifiers in a local session cache, allowing reuse across multiple agent requests requiring the same target.

In an embodiment, communication proxy 130 supports logical target resolution. Communication proxy 130 applies selection rules that may consider various metrics and policy constraints before selecting an endpoint for connection. Communication proxy 130 stores resolution results for a configurable duration and may periodically refresh entries.

In an embodiment, communication proxy 130 manages credentials by querying connection store 168 for authentication information associated with the selected connection profile. Connection store 168 stores secrets in an encrypted format and exposes retrieval interfaces based on role-based access policies. Communication proxy 130 requests credentials by specifying the credential reference and operation type, such as mutual TLS handshake or token-based authorization. Communication proxy 130 injects the retrieved credential into the outbound connection metadata, using appropriate encoding formats based on the protocol in use. Communication proxy 130 may rotate credentials by detecting expiration timestamps and triggering refresh operations in coordination with connection store 168.

In an embodiment, communication proxy 130 supports monitoring and audit collection by logging requests and response transactions. Communication proxy 130 may tag log entries with correlation identifiers derived from the request metadata to support distributed tracing. Communication proxy 130 also supports generating structured metrics and sending the structured metrics in activity log 166.

In an embodiment, communication proxy 130 supports policy enforcement by invoking policy evaluation module 138 before routing any request. Communication proxy 130 provides the policy evaluation module 138 with contextual parameters, such as caller identity, destination type, request size, and access level. Policy evaluation module 138 returns an allow or deny decision. Communication proxy 130 either forwards the request or returns a policy violation response. Policy decisions may be cached locally by communication proxy 130 under time-based or usage-based invalidation strategies.

In accordance with one or more embodiments, communication proxy 130 is configured to generate connection advertisements that indicate a connection type. Connection types may include data retrieval and exchange connection types. For example, connection types may include SQL database connections such as JDBC (Java Database Connectivity) or ODBC (Open Database Connectivity), facilitating structured queries and interactions with relational databases. SAP connections utilize certain function calls, for example, to access and manipulate enterprise resource planning data and processes. Web-based connections, such as RESTful APIs (Representational State Transfer Application Programming Interfaces) or SOAP (Simple Object Access Protocol) web services, provide standardized methods for retrieving data from various applications. Other connections may use file transfer protocols to enable data transfer between systems. Connection types may also include types that are not primarily oriented toward data transfer, such as remote desktop protocols, secure shell protocols, and protocols for communicating with devices, for example.

Communication proxy 130 may share connection advertisements or otherwise make connection advertisements available to agents in agent execution environment 120. In an embodiment, communication proxy 130 broadcasts connection advertisements to agents. In another embodiment, communication proxy 130 stores connection advertisements in a configuration file accessible to agents. communication proxy 130 may also communicate directly with agents in response to detecting that an agent has been deployed to an execution environment but is not configured to use communication proxy 130 for a connection. Alternatively, communication proxy 130 may be configured to detect and respond to connection requests from agents.

In accordance with one or more embodiments, discovery agent 122 is configured to connect to marketplace management system via interface 150. Discovery agent 122 retrieves agent records that match requests sent to discovery agent 122 by users, agents, or other components of agent workspace 100. Discovery agent 122 receives requests from an interface, parses the input to extract request terms and filter parameters, and constructs a request formatted for compatibility with interface 150. For example, a request may indicate a data or connection type that an agent will need to use to perform duties to be assigned to the agent as part of a workflow. Discovery agent 122 may receive structured queries or natural language queries that are interpreted by Discovery agent 122 or an interpreter or machine learning model associated with discovery agent 122. Discovery agent is configured to determine if multiple agents are needed to satisfy the request requirements and issue requests to martketplace management system 140 to find agents that may fit the workflow requirements. Discovery agent 122 may include query metadata, such as user region, device type, or language preference, to support result refinement. Discovery agent 122 transmits the request to interface 150, and interface 150 forwards the request to catalog module 144 for processing.

In accordance with one or more embodiments, discovery agent 122 is configured to receive structured response data from catalog module 144 through interface 150. Discovery agent 122 parses the response, extracts application identifiers, titles, descriptions, and other relevant metadata, and returns the results to the calling context in a structured format. Discovery agent 122 may apply additional client-side filtering or ranking rules based on application popularity, rating, or compatibility. Discovery agent 122 supports pagination, sorting, and dynamic query modification to allow users to refine searches without reinitializing the session.

In accordance with one or more embodiments, discovery agent 122 facilitates the installation of agents within the agent execution environment. Discovery agent 122 may perform installation operations automatically or in response to user input. For example, if discovery agent 122 is configured to return a list of available agents that match the request with a degree of certainty, discovery agent 122 may wait for user input to initiate installation of agents selected by the user. In an embodiment, any other element of agent workspace 100 may facilitate the installation of agents to the agent execution environment 120. In an embodiment, marketplace management system 140 facilitates the installation of agents into agent execution environment 120.

In accordance with one or more embodiments, agent A 124 is a process instantiated within agent workspace 100 and hosted in execution environment 120 for the purpose of executing a defined task or service function. Agent A 124 may be instantiated by workspace orchestration module 102 based on a received task graph or execution plan, and the configuration parameters used for instantiation are derived from integration module 110 and privacy and security module 104. Agent A 124 comprises runtime logic, communication bindings, and, optionally, access credentials scoped to a specific function class. In an embodiment, agent A 124 does not include configuration parameters for access credentials but instead relies on communication proxy 130 for access to data sources or to facilitate other connection requirements. Agent A 124 may operate independently, as part of a multi-agent workflow in the workspace, or as part of a workflow that spans multiple execution environments and service boundaries. In an embodiment, agent A 124 may cause another agent workspace or a separate execution environment to be instantiated. Lifecycle events for agent A 124 are tracked and updated in internal state registries for coordination across the platform and may be stored in activity log 166 along with any other log files generated by the one or more of the systems described with respect to FIG. 1.

In accordance with one or more embodiments, agent A 124 may be configured as a data connector agent that establishes and maintains connections with structured or unstructured data sources. Examples of this class of agent A 124 include a structured query language (SQL) query agent that performs parameterized queries against a relational database, a database interface agent that handles document retrieval and aggregation tasks, and a cloud computing container ingestion agent that reads from or writes to an object storage container or bucket. Agent A 124 may receive connection parameters and/or credential information from communication proxy 130 and use those inputs to initiate secure connections with communication proxy 130. Communication proxy 130 initiates connections with requires targets on behalf of agent A 124. Once connected, agent A 124 transmits query results or ingest summaries to other agents or external systems through inter-communication module 108 and input/output module 128. Metrics, such as query latency, transfer volume, and connection stability, are reported to analytics module 106.

In accordance with one or more embodiments, agent A 124 may also be configured to perform transformation, orchestration, or monitoring tasks in support of higher-level workflows. For example, agent A 124 may be an agent that performs the transform phase of an extract, transform, load (ETL) pipeline that receives raw data from a connector agent and applies mapping logic defined in execution metadata. Alternatively, agent A 124 may serve as a task coordinator agent that aggregates signals from multiple agents, evaluates conditional logic, and produces intermediate outputs for downstream consumption. In monitoring scenarios, agent A 124 may observe external endpoints, collect system metrics, and push telemetry to external observability platforms using integration module 110. These variations are supported by parameterized configuration templates stored in workspace orchestration module 102 and retrieved during agent provisioning.

In accordance with one or more embodiments, agent A 124 may be configured to support machine learning inference, model coordination, or classification logic using an associated model reference and persona specification. In this configuration, Agent A 124 may comprise, for example, a model execution engine, feature pre-processing routines, and output post-processing modules that execute in a containerized context within execution environment 120. The model artifact may be retrieved from a model registry service referenced through integration module 110, using identity and authorization tokens provided by privacy and security module 104 or a connection with communication proxy 130. The persona assigned to agent A 124 defines behavioral characteristics, context boundaries, and access constraints that influence how the model is applied during task execution. For instance, a diagnostic persona may prioritize precision and provide detailed confidence intervals, while a summarization persona may suppress low-salience information and produce short-form outputs.

In accordance with one or more embodiments, agent A 124 may also specify a required input data type or schema to define the agent's activation conditions and upstream dependencies within a task graph. The required data specification may include structured formats, like tabular datasets, time-series signals, or hierarchical JSON documents, or unstructured inputs, such as free-text or image data. Agent A 124 receives data access instructions via communication proxy 130. The type and classification of input data may be evaluated by privacy and security module 104 to determine any redaction, filtering, or encryption operations required before data is exposed to agent A 124. Input/output module 128 may apply format transformations or transport adaptations to deliver the input in a format compatible with agent A 124's runtime configuration.

In accordance with one or more embodiments, agent A 124, with a model and persona assignment, may participate in a multi-agent workflow. For example, a user-facing agent that is also deployed to agent execution environment 120 may be configured to pass pre-processed natural language input to agent A 124, where agent A 124 executes a large language model associated with an analytical persona to generate a contextual recommendation. Output from agent A 124 may be routed to a decision agent or policy evaluation module for downstream action selection or transmitted externally through inter-communication module 108. Agent A 124 logs inference metadata, model confidence scores, and output structure to analytics module 106 for analysis and performance monitoring.

In accordance with one or more embodiments, marketplace management system 140 is configured to manage the end-to-end lifecycle of agents offered through a centralized distribution platform. Marketplace management system 140 coordinates interactions between management module 142, catalog module 144, distribution module 146, commerce module 148, and interface 150. Marketplace management system 140 receives agent submissions and associated metadata from external systems through interface 150, validates the inputs based on predefined policies, and stores structured records for further processing. Marketplace management system 140 maintains internal references between agent identifiers, developer accounts, version information, and regional availability.

In accordance with one or more embodiments, marketplace management system 140 is configured to support publishing workflows, compliance checks, catalog updates, and user access operations. Marketplace management system 140 processes state transitions for agents, such as moving from draft to published or from published to suspended, by invoking logic from management module 142 and catalog module 144. Marketplace management system 140 may emit internal signals to distribution module 146 when new binaries become available or when published metadata changes. Marketplace management system 140 also supports monitoring and diagnostic features by recording transaction summaries and operational logs associated with module activity. The operational logs may be used for governance purposes.

In accordance with one or more embodiments, management module 142 is configured to store and update agent records, manage developer access rights, and control agent versioning. Management module 142 maintains mappings between developer identities and agent identifiers and verifies that requested changes comply with authorization policies. Management module 142 accepts new version submissions by recording version metadata and associating versions with agent-level attributes, such as visibility, release track, and default locale. Management module 142 performs version state management by transitioning version records through different states, such as pending, approved, rejected, or deprecated.

In accordance with one or more embodiments, management module 142 is configured to enforce constraints on agent names and identifiers, ensure consistency of agent metadata, and apply administrative overrides when necessary. Management module 142 receives requests to modify agent-level settings, such as target platforms, content classification, and category assignment, and validates those changes against existing policies and historical records. Management module 142 may also generate audit entries and apply review workflows before changes take effect. Management module 142 works with catalog module 144 to propagate version-level metadata to user-facing catalogs when a version transitions to the published state.

In accordance with one or more embodiments, catalog module 144 is configured to manage the storage and retrieval of metadata associated with published agents. For example, agent metadata 164 may be stored in data repository 160. Catalog module 144 stores agent metadata 164 as structured data fields, such as type, connection requirements, titles, descriptions, icons, screenshots, supported devices, and localized text variants. Catalog module 144 organizes records by publication region, platform compatibility, and availability status, supporting filtered retrieval based on these criteria. Catalog module 144 supports search indexing and metadata updates as well as prepares data for consumption by interface 150 or by downstream rendering systems that generate listings.

In accordance with one or more embodiments, catalog module 144 is configured to respond to updates from management module 142 when agent metadata changes or when version records transition to the published or removed state. Catalog module 144 updates internal indices and display lists to reflect new availability or to remove obsolete content from search and browse results. Catalog module 144 prepares catalog responses for various contexts, such as recommendations, featured listings, or search result rankings. Catalog module 144 may cache result sets for efficiency and listen for updates triggered by changes in agent status or content fields. Catalog module 144 may be configured to display, list, or return lists of modules based on a variety of preferences that may be configured. For example, an administrator may indicate a preference for one or more particular agents that are preferred based on the type of connection, type of data, or other agent metadata.

In accordance with one or more embodiments, distribution module 146 is configured to manage the retrieval and delivery of agent binary files, stored as agents 162 in data repository 160. Distribution module 146 responds to agent download and/or deployment requests by selecting the appropriate version and variant of a package based on the request context, including device characteristics, region, and network capabilities. Distribution module 146 accesses binary content from internal storage or from a content delivery network and may generate pre-authenticated access tokens or time-limited URLs to control access. Distribution module 146 tracks download activity and stores metadata, such as client identifier, timestamp, and package version.

In accordance with one or more embodiments, distribution module 146 is configured to support version targeting and staged rollout. Distribution module 146 applies delivery rules defined by management module 142 to determine the users eligible to receive a particular version. Distribution module 146 may assign users to rollout cohorts and incrementally increase availability based on rollout progression settings. Distribution module 146 also handles revocation of specific package versions in response to policy violations or technical issues and blocks download attempts for revoked content based on updated delivery configuration.

In accordance with one or more embodiments, commerce module 148 is configured to process agent-related transactions, such as one-time purchases, subscriptions, and payments associated with agents. Commerce module 148 validates pricing and product identifiers, verifies transaction context, and interacts with payment processing systems to complete authorization and settlement. Commerce module 148 maintains records of completed transactions, failed attempts, and refund requests. Commerce module 148 associates purchase records with user accounts and stores entitlement records that reflect user access to specific agents or content.

In accordance with one or more embodiments, commerce module 148 is configured to calculate and distribute revenue based on developer agreements and transaction records. Commerce module 148 assigns revenue shares based on pricing models and agreement terms as well as generates periodic payout summaries for developer accounts. Commerce module 148 exposes entitlement data to interface 150 to support user queries and license verification. Commerce module 148 also supports refund workflows and license revocation, updating entitlement records accordingly when a refund is processed or a purchase is canceled.

In accordance with one or more embodiments, interface 150 is configured to expose APIs and graphical tools for interacting with marketplace management system 140. Interface 150 handles authenticated requests for submitting agents, managing versions, browsing the catalog, downloading agents, and performing transactions. Interface 150 supports both developer-facing and user-facing interactions, applying rate limits, validating request formats, and routing requests to the appropriate internal module. Interface 150 also supports rendering localized views and content bundles based on client region and language preferences.

In accordance with one or more embodiments, interface 150 is configured to support session tracking and user activity logging. Interface 150 issues session tokens upon successful authentication and stores session metadata, such as expiration time and client type. Interface 150 logs actions, such as agent updates, purchase activity, and content access, to internal logging systems for review and analytics. Interface 150 works with catalog module 144 to render catalog content and with commerce module 148 to present purchase options and entitlement status for agents.

In accordance with one or more embodiments, data repository 160 is any type of storage unit and/or device (e.g., a file system, database, collection of tables, or any other storage mechanism) for storing data. Furthermore, data repository 160 may include multiple different storage units and/or devices. The multiple different storage units and/or devices may or may not be of the same type or located at the same physical site. Furthermore, a data repository 104 may be implemented or executed on the same computing system as one or more of the systems described with respect to FIG. 1. Additionally, or alternatively, a data repository 104 may be implemented or executed on a computing system separate from one or more of the systems described with respect to FIG. 1. The data repository 104 may be communicatively coupled to one or more of the systems described with respect to FIG. 1 via a direct connection or via a network.

Information describing agents 162, agent metadata 164, activity log 166, and connection store 168 may be implemented across any of components within the one or more of the systems described with respect to FIG. 1. However, this information is illustrated within the data repository 104 for purposes of clarity and explanation.

In one or more embodiments, one or more of the systems described with respect to FIG. 1may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6 titled “Computer Networks and Cloud Networks.”

In one or more embodiments, a machine learning algorithm is an algorithm that can be iterated to train a target model f that best maps a set of input variables to an output variable. In particular, a machine learning algorithm is configured to generate and/or train a model.

A machine learning algorithm is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

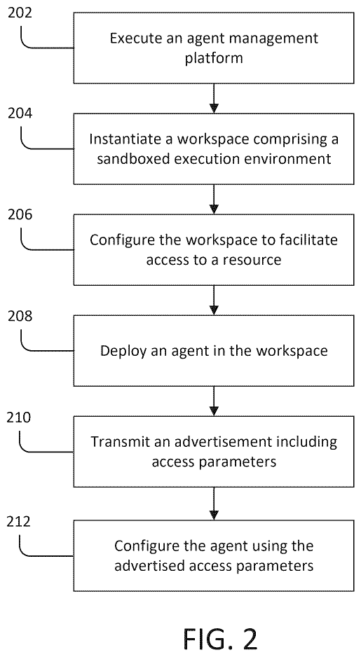

In one or more embodiments, agent workspace 100 and marketplace management system 140 refer to hardware and/or software configured to perform operations described herein for agent workspace 100 and marketplace management system 140. Examples of operations for agent workspace 100 and marketplace management system 140 are described below with reference to FIGS. 2-4.

In an embodiment, agent workspace 100 and marketplace management system 140 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a user interface such as interface 150 refers to hardware and/or software configured to facilitate communications between a user and marketplace management system. Interface 150 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 150 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 150 is specified in one or more other languages, such as Java, C, or C++. In an embodiment, one or more of the other elements described in FIG. 1, such as input/output module 128, may include an interface with the features described in connection with interface 150.

### 3. MANAGING AGENTS IN A WORKSPACE

FIG. 2 illustrates an example set of operations for operating agents in a workspace in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system executes an agent management platform (Operation 201). This includes initializing isolated workspaces for agents, provisioning runtime environments, and coordinating the registration, scheduling, and monitoring of agent activity. The platform loads configuration data that defines agent behavior, resource limits, network permissions, and execution policies. The agent management platform assigns agents to available workspaces and configures the necessary environment variables, credentials, and dependencies to allow agents to operate within an assigned scope.

In an embodiment, the platform tracks agent health, logs output, and responds to lifecycle events, such as startup, failure, or termination. Agents may report telemetry back to the platform, including status updates, resource usage, and task results. The platform uses this information to trigger scaling actions, reassign workloads, or shut down idle agents. In systems where multiple agents run concurrently, the platform manages isolation and resource sharing using scheduling policies, container orchestration, or virtual machine provisioning, depending on the architecture and runtime model.

In an embodiment, the system instantiates a workspace comprising a sandboxed execution environment (Operation 204). The instantiation process involves allocating compute and memory resources, configuring environment variables, and setting up access controls that define what services, data, or system interfaces are visible within the workspace. The filesystem structure may be mounted from a predefined template or dynamically constructed based on the parameters provided at initialization. The network configuration is scoped to the workspace, optionally restricting external connectivity or limiting access to specified endpoints. The workspace is brought to a runnable state with an isolated process namespace and any required runtime dependencies preloaded into the environment.

In an embodiment, the system prepares the workspace for task execution by finalizing the runtime context and verifying that isolation boundaries are in place. This includes initializing logging mechanisms, assigning temporary or persistent identifiers, and registering the workspace with any relevant tracking systems. Security policies are applied to control file access, process capabilities, and inter-process communication within the workspace. The workspace remains idle until a task is assigned. Once a task is assigned, the workspace may accept code, data, or other inputs for execution. The workspace may persist across tasks or be terminated after a single use, depending on system configuration.

In an embodiment, the system configures the workspace to facilitate access to a resource (Operation 206). The workspace includes communication proxy logic that serves as an intermediary acting on behalf of agents for accessing resources. The system configures the proxy to access resources by defining logical destination identifiers, connection profiles, and associated credentials in a centralized configuration store. Connection profiles specify one or more service endpoints, supported protocols, and credential references, allowing the proxy to determine how to route and authenticate requests based on runtime inputs. The configuration may also include policy rules, load balancing preferences, and tenant-specific constraints. The proxy evaluates the constraints when selecting an endpoint or applying access controls.

Credential access is configured through references embedded in the connection profiles. The proxy resolves the connection profiles against a credential store secured by role-based policies. The proxy determines the types of authentication that are required and available, such as mutual TLS, API keys, or token-based schemes, and the proxy retrieves and applies the appropriate credentials at connection time. Policy enforcement and monitoring behavior are likewise configurable, allowing users to define what metadata to log, how long to cache decisions or resolution data, and what transformation rules to apply to incoming requests. This modular configuration model enables the proxy to be reused across environments while adapting dynamically to operational or security requirements.

In an embodiment, the system deploys an agent in the workspace (Operation 208). Deployment is performed by injecting executable code, configuration data, and any required credentials or tokens. The agent begins execution within the workspace's runtime, accessing system APIs, services, or data sources permitted by the workspace context. The system monitors execution state, enforces resource limits, and collects telemetry data, such as exit codes, log output, and runtime metrics. Upon completion, failure, or expiration of the agent's task, the system may terminate the workspace and perform cleanup operations, including revoking credentials, deleting temporary data, and releasing allocated resources.

In an embodiment, selection of the agent to be deployed may be performed directly by a user, directly by an agent, or through a discovery agent configured to find agents in an agent marketplace. For example, when a workspace is instantiated, a discovery agent may be deployed in the workspace to facilitate agent selection. A discovery agent may be associated with one or more agent marketplaces or catalogs and configured to assist with discovery of agents that are capable of handling a business objective.

In an embodiment, the selection and/or deployment of the agent may be performed in response to receiving a deployment request. The deployment request may be received from a user, service, or other entity. The deployment request includes various details that enable the system to select and deploy an agent. For example, the deployment request may include an agent type, a connection type, and/or a function to be performed by the agent when deployed in the execution environment. A deployment request may include metadata about the requestor or organization information to help with the agent selection process. For example, if two organizations use different tools to perform similar objectives, then an otherwise identical deployment request from one organization may result in the selection or deployment of a different agent for the same task or function than another organization.

In an embodiment, an agent may be deployed with agent-specific credentials. These credentials may be provided automatically by the agent or system deploying the agent. The agent-specific credentials may be required for the agent to access the agent execution environment. In an embodiment, agent-specific credentials may be required for performing certain operations within the agent execution environment.

In an embodiment, a user may provide a business objective to the workspace. For example, a business objective may include drafting a report using a specific data set available via a database. The objective may be stated in precise terms or in natural language. A machine learning model may interpret the business objective to determine the agents that are required and the configured connections that are useful. Based on the machine learning model interpretation or other interpretation of the business objective, the discovery agent configures a context-aware objective associated with the workspace or a workflow within a workspace. A context-aware business objective is an objective that is associated with the context of a particular workspace. The context of a workspace may include permissions, constraints, and available resources for agents deployed in the workspace, including specific system APIs, accessible services, connections, designated data sources, security policies, authentication and authorization mechanisms, resource quotas or limits, execution environments, and any regulatory or compliance requirements governing the workspace's operation and the use of data. For example, the context-aware objective may associate a business objective of preparing an expense report with the context of available connections, configurations, and/or targets associated with the workspace or with one or more workflows associated with the workspace. The workspace may be configured to allow agents to access an expense reporting system, such as Oracle Fusion Cloud Expenses, including the necessary connections and permissions for agents in the workspace.

The system also associates the context-aware objective with one or more agent types based on an analysis of the business objective by a machine learning model. The discovery agent determines the agents in the agent marketplace that can be used to satisfy the requirements, considering the context-aware objective. An agent type is determined by the requirements and capabilities of the agent. Each agent type may be associated with an identifier that may be numerical or alphanumeric. For example, an “SQL_Oracle” agent type may represent agents that are able to interact with Oracle database systems using structured query language (SQL). Such an agent is constrained by the type of connection required, and characterized by the capability of taking advantage of features provided by Oracle database systems.

In an embodiment, agents are associated with corresponding agent manifests that identify configured target types that the associated agent is able to interact with. In an embodiment, a discovery agent manages the selection process based on an agent type that corresponds to a context-aware objective or a portion of the context-aware objective by matching the agent type corresponding to the context-aware objective with an agent type in a manifest corresponding to an agent. For example, the system or the discovery agent may determine that a particular resource is required for the performance of the context-aware objective, and that the resource provides data via an interface that responds to SQL queries. The discovery agent will search within an agent catalog for agents of a type that are capable of issuing SQL queries. The available connections within the context of the workspace may be matched with the connections capabilities of an agent type in an embodiment, The system discovery agent may automatically deploy an agent. In some instances, the automatic deployment is based on a determination that the appropriate type of agent has been selected based on the context-aware objective, so no human intervention is required.

In an embodiment, the context-aware objective may change based on subsequent requests made in the workspace, and existing agents assigned based on a previous context-aware objective may no longer be relevant to the updated context-aware objective. In such a case, the agents that are no longer relevant may be decommissioned, and the selection process may be initiated again.

In an embodiment, the system receives a discovery request to search for agents with particular capabilities. Similar to a deployment request, a discovery request may contain information related to the task or function to be performed, the type of agent to search for, organization information, data types supported by the agent, and other information. The discovery request, like a deployment request, may include criteria such as target type, task category, environment constraints, or user role. The system responds to a discovery request by presenting a list of agents retrieved from the agent marketplace. Based on the request parameters, the system queries the agent marketplace for agents that match the criteria and retrieves metadata describing results, such as name, version, supported protocols, and compatibility attributes. The resulting list is formatted and returned to the requesting client or interface for display.

In an embodiment, if the discovery request specifies multiple roles or functional categories requiring separate agent selections, the system generates two or more distinct lists of agents. Each list corresponds to a different requirement in the discovery request, such as source and destination processors or monitoring and execution agents. The lists are presented to the user in a structured format with clear labels and grouping to distinguish between the different selection contexts. Each list may support search, filtering, and pagination independently.

In an embodiment, the user selects one or more agents from each list to fulfill the composite requirements of the discovery request. The system receives the selected agent identifiers and validates compatibility across the selections, such as checking for protocol alignment or shared resource access. Upon validation, the system associates the selected agents with the current session, workflow, or deployment plan, and may trigger subsequent configuration or provisioning actions. This approach supports modular composition of tasks and dynamic selection of agents based on user intent or system recommendations.

In an embodiment, the system transmits an advertisement that includes access parameters (Operation 210). The access parameters may be parameters that allow the agent to connect directly to the resource, or the access parameters may be parameters for the agent to connect to a communication proxy such as communication proxy 130. The parameters may include, for example, the following: a proxy endpoint address comprising the network location of the connection proxy, such as a hostname or IP address, and a port number; a logical destination identifier, such as a hostname, that represents the target service; a protocol type that identifies the transport or application protocol that is required for the connection; authentication metadata, such as a token, API key, certificate, or other credentials needed to authenticate the agent to the communication proxy; tenant or context identifier, region code, or other information required for communication in a multi-tenancy system; and/or connection preferences, such as timeout settings, retry policies, and other preferences.

In accordance with one or more embodiments, the advertisement indicates a correlation between access parameters and agent types. For example, the advertisement may indicate that the particular access parameters are for an agent that handles SQL queries. Agent types may be associated with identifiers that are used for matching. If the system or an agent attempts to find matching access parameters, the system or agent may use an agent type identifier to match the agent type associated with the agent with the agent type associated with the access parameters. This allows the agent or system to ignore access parameters that are not relevant to the agent being configured. The agent type-specific parameters may include a separate identifier associated with the connection to distinguish the connection for one service or resource from a connection for another service or resource. For example, agents may use the same proxy to access different resources. Using the connection identifier in communications allows the proxy to ensure that requests are routed to the proper resource.

In accordance with one or more embodiments, the advertisement transmission may start by first encoding the advertisement and associated data into a structured format, such as JSON, XML, or a binary protocol buffer. The structured data may be temporarily written to a file or stored in an in-memory buffer. This file or buffer may used to encapsulate required data elements for transmission and may be compressed or encrypted prior to sending to reduce payload size and enhance security.

In an embodiment, the transmission occurs via an inter-system communication mechanism, such as an HTTP-based RESTful API, message queue (e.g., Kafka or AMQP), or a dedicated advertising protocol such as OpenRTB. The system may push the advertisement data directly to the destination platform or publish it to an intermediary broker or exchange for further routing. Authentication tokens, routing metadata, and content integrity checks may be embedded within headers or envelopes of the transmitted data.

In an embodiment, the system configures the agent using the advertised access parameters (Operation 212). The system configures the agent, or the agent configures itself to communicate through the connection proxy by retrieving the connection parameters. The connection parameters may be retrieved at initialization time or while the agent is executing. For example, the parameters may be retrieved from any advertisement of the parameters by the system, such as a broadcast, a configuration file, environment variables, a remote configuration service, or a deployment manifest associated with the runtime environment of the agent. The agent loads these values into memory and provides them to a connection handler or client library responsible for issuing outbound requests.

In an embodiment, the agent uses a proxy endpoint address to establish a network-level connection to the connection proxy. In an embodiment, the agent communicates with the proxy via a message handler within the workspace using minimal parameters such as a proxy identifier. In an embodiment, the logical destination identifier is included in the request payload or headers to allow the proxy to resolve the intended target. The agent formats the outbound request in accordance with the specified protocol type and attaches the authentication metadata required for the proxy to validate the request. If a context identifier is provided, the agent includes it in the request metadata to support multi-tenant routing or policy enforcement within the proxy. Additional preference parameters, such as timeout thresholds or retry behavior, may be registered with the local connection logic to shape how subsequent requests are handled. Once the parameters are applied, the application routes connection requests through the connection proxy rather than directly to the destination service.

In an embodiment, the agent is configured using the agent type identifier. For example, the agent references the agent type identifier when initiating a connection request to the connection proxy. Alternatively, a connection type identifier may be used in place of an agent type identifier. The agent type identifier uniquely or semi-uniquely identifies a specific agent capability or connection requirement. A connection type identifier may be assigned statically through configuration or dynamically during a provisioning phase and is used by the connection proxy to distinguish among multiple connection definitions, policies, or target mappings. In an embodiment, both an agent type identifier and a connection type identifier may be used.

In an embodiment, the agent embeds the agent type identifier into the metadata of the outbound request, such as in a custom header field, query parameter, or connection context object. When the agent type invokes the connection logic, the agent type identifier is retrieved from the local configuration or runtime context and passed along with the request. The connection proxy receives the agent type identifier and uses it to retrieve a corresponding connection profile. The connection profile may define the destination endpoint, transport protocol, authentication method, access scope, and policy constraints. The proxy uses this information to construct the outbound connection to the correct target system and to apply any connection-specific logic, such as logging, transformation, or access control enforcement. In an embodiment, the proxy may use an existing connection to the target system or resource.

In an embodiment, the agent type identifier may also be used for session tracking or performance monitoring. The proxy associates the identifier with connection lifecycle events, allowing system operators or automated tools to trace usage patterns, failure events, or policy violations related to specific identifiers. This approach allows the agent to remain decoupled from the underlying connection logic while still supporting differentiated treatment of connections based on identifier values. An agent identifier may also be shared in connection with requests to the proxy, resulting in additional transparency for governance purposes.

In an embodiment, an agent uses a defined set of access parameters to initiate communication with a connection proxy. These access parameters comprise a proxy endpoint address and a target type identifier. The proxy endpoint address specifies the network location of the connection proxy, such as a hostname and port number. The target type identifier indicates the class or protocol of the target system that the agent intends to reach. Target types may include various values, such as SQL server, s3, https, or other service categories recognized by the proxy. The access parameters may be stored in configuration files, retrieved from a configuration management system, or injected into the agent at runtime.

In an embodiment, the agent constructs a connection request that includes the access parameters and transmits the request to the connection proxy. The request may be formatted as an HTTP call, gRPC message, or other protocol-compliant message, depending on the interface exposed by the proxy. The connection proxy parses the request, extracts the target type, and uses that value to determine how to handle the connection. The connection proxy may consult an internal registry or mapping table that associates target types with connection handler logic, connection profile templates, or routing policies. The selected handler is responsible for constructing the outbound connection based on the semantics of the target type.

In an embodiment, the connection proxy brokers the connection by resolving the connection parameters associated with the target type and creating a live connection session to the appropriate backend. For example, if the target type is an SQL server, the proxy may retrieve credentials, endpoint address, and driver settings from a configuration store or secrets manager. The proxy instantiates a protocol-compliant client or connection pool configured with those parameters and establishes a network connection to the SQL server instance. This connection may be created on-demand or drawn from a managed pool, depending on the system design. The proxy retains a reference to the connection session and associates it with metadata from the original request.

In an embodiment, the connection proxy acts as an intermediary for traffic flowing between the agent and the target system. The proxy receives protocol-level requests from the agent, translates or forwards those requests to the target system, and relays responses back to the agent. The proxy may perform intermediate functions, such as protocol translation, authentication injection, or response transformation, based on rules associated with the target type. The proxy maintains a connection state as needed, supporting either stateless forwarding or stateful multiplexing, depending on the nature of the target protocol.

In an embodiment, the connection proxy may support multiple simultaneous connections across different target types and agent contexts. Connection request received by the proxy are evaluated independently, and a separate backend connection is created or reused based on the combination of target type, caller identity, and any context metadata included in the request. The proxy may assign session identifiers or correlation tokens to connections to facilitate logging, monitoring, and error handling. These identifiers allow the proxy to maintain observability across dynamic workloads and support granular diagnostics without requiring the agent to manage the underlying connection details.

In an embodiment, the connection proxy may determine that the original target for a particular connection is no longer the best target for that connection type or agent type. For example, a new target may include more updated information or may be a new source of truth for certain types of data. If a company changes expense reporting services, for example, an agent configured to manage expense reports will need to connect to the new expense reporting system as a target rather than the old system. In addition, agents may be configured to connect to particular target systems or types of target systems. In the expense report example, if the agent is no longer useful after the change in expense reporting systems, a new agent may be introduced, either manually or automatically.

In an embodiment, monitoring an activity log allows a system to determine when a new agent or connection is being used for a particular type of traffic by analyzing request metadata over time. Requests handled by the connection proxy are recorded with data, such as timestamp, caller identity, connection identifier, target type, and optional protocol attributes. When a source that has not previously initiated traffic toward a specific target type begins to do so, the presence of that new request pattern in the log provides an indicator that a different agent or connection may be active. The system can track this shift by comparing current entries to historical records.

In an embodiment, an agent may be deployed to satisfy a context-aware objective, but then may subsequently fail to satisfy to satisfy the objective. In addition, it is possible that the deployed agent may be irrelevant to the context-aware objective or may be determined to be less effective at satisfying the context-aware objective than a different or newer agent. For example, activity log files may indicate that an initially-deployed agent has suddenly started failing to perform an assigned function. This may happen for a variety of reasons. As one example, the initially-deployed agent may be configured to use connection parameters that are no longer valid. As another example, the initially-deployed agent may be configured to connect to an older type of system, and the function of that system has been migrated to a newer system (e.g., the system used to submit expense reports is now a different system from a different vendor). In such cases, the system may determine that an initially-deployed agent is now irrelevant for the context-aware business objective for which the agent was initially deployed.

In an embodiment, the system uses the activity log to detect trends for new agent deployments for the same or similar context-aware business objective. For example, deployment analysis logic may be used to monitor log files to determine if initially-deployed agents are being selected by discovery agents, and even if the initially-deployed agents show up in search results in discovery requests when paired with the same or similar context-aware business objective.

In an embodiment, if new deployments for the same business objective are consistently associated with different agents (not the initially-deployed agent), the system may trigger an inspection of log files associated with the initially-deployed agent. If the initially-deployed agent appears to be functioning correctly but other agents are consistently deployed (e.g., in other workspaces) to support the same business objective, an alert may be triggered to notify the business owner of the discrepancy. Such a case may arise, for example, during a migration period such as the migration of expense reporting systems used in the example above.

In an embodiment, the system may determine from the activity log files that the initially-deployed agent is not functioning properly. In such a case, an alert may be triggered. If the system determines from the activity log files that a different agent is better suited to perform the context-aware business objective, then the system may disable or remove the initially-deployed agent and replace it with a new agent that is better-suited for the function. For example, the system may initiate a discovery request using a discovery agent, providing the context-aware business objective. If the initially-deployed agent does not appear in the results provided in response to the discovery request, the system may determine that the initially-deployed agent is no longer relevant to the context-aware business objective for which it was initially deployed. In this case, the system may deploy the best agent for the context-aware business objective to perform the function. In an embodiment, workspaces may be configured to perform periodic “check-ups” to determine if the initially-deployed agents are still appropriate for the functions for which they were deployed, and take action to replace the agents as needed.

In an embodiment, the system evaluates connection records based on various factors, such as client identifiers, authentication tokens, IP ranges, or embedded request headers, to determine if a connection originates from a new source. If the connection proxy supports unique session or trace identifiers, those can be used to group activity into logical units and detect new agent or connection behavior. The system may correlate this activity with a context-aware objective to determine if the context-aware objective is being satisfied. When multiple connection attempts from an unfamiliar source consistently target a known service type, the system can infer that a new agent or connection is interacting with that service.

In an embodiment, tracing data helps correlate request activity across multiple components and determine the context of the operations. When the connection proxy tags requests with trace identifiers and span metadata, downstream systems can propagate and log those identifiers along the execution path. The collected trace data allows reconstruction of request flows and identification of the originating agent or connection, even across service boundaries. If a new trace root appears with request patterns matching a specific target type, the system interprets that as the introduction of a new agent, connection, or workload segment generating traffic of that type.

In an embodiment, the system performs periodic analysis of log data and trace records to identify access patterns that differ from established norms. This may involve time-windowed aggregation, comparison of source identifiers, or classification based on known agent or connection fingerprints. When a combination of target type, caller metadata, and request structure does not match any existing profile, the system may flag the activity as associated with a new agent or connection. This process supports dynamic registration, access review, and traffic segmentation in environments where a new agent or connection may appear without manual onboarding.

In an embodiment, an agent or workspace may instantiate one or more additional workspaces. Each workspace may be associated with a workspace-specific set of connection or access parameters, permissions, and agents. An agent of a particular type in one workspace may connect, via a proxy or direct connection, with a different target system than an agent of the same type in a different workspace. Alternatively, the behavior of elements of each workspace may be the same or similar to the behavior of elements of other workspaces.

For example, in an embodiment, a second workspace may be instantiated. The instantiation of the second workspace may result from a direct user request, from an automated process, or as the result of a trigger from another system or agent. The second workspace may be configured to facilitate access to a different set of resourced than the first workspace. In other words, the second workspace may be configured with access parameters for resources that are not available to agents in the first workspace discussed above. An agent may be deployed in the second workspace in response to a deployment request. The deployed agent may be an agent from the same marketplace used by the first workspace, or may be from a different marketplace. The deployed agent may be the same agent that was deployed in the first workspace, in which case it is a different instance of the same agent. The system transmits an advertisement that includes connection parameters for a resource that is not available to agents in the first workspace. For example, the parameters may be connection parameters for a database service that were not configured within the first workspace. Based on the access parameters advertised, the deployed agent is configured to access the resource.

In an embodiment, there is no limit to the number of workspaces that may be instantiated by the system. Furthermore, there is no limit to the number of marketplaces and associated discovery agents that may be used by the workspaces in the system. Likewise, the combinations of connections and agents may be distinct across workspaces, and are without limit.

### 4. EXAMPLE EMBODIMENT A

A detailed example is described below for purposes of clarity. Components and/or operations described below should be understood as one specific example which may not be applicable to certain embodiments. Accordingly, components and/or operations described below should not be construed as limiting the scope of any of the claims.

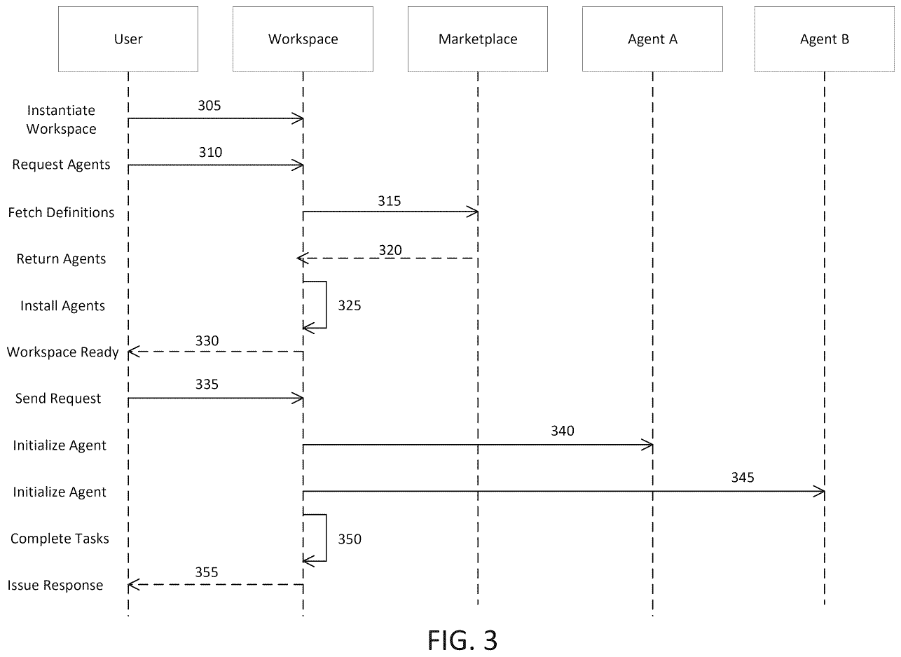

FIG. 3 illustrates an example set of operations for operating agents in a workspace in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, creating a workspace begins when a user submits a request to instantiate a workspace, with the request specifying the desired characteristics of the workspace (Operation 305). For example, the request may specify a runtime type, one or more resource constraints, and/or an associated execution context of the workspace. The system receives the request and allocates a sandboxed environment that satisfies the provided parameters. The workspace is instantiated with isolated compute and memory resources, predefined environment variables, access policies, and optionally preconfigured storage mounts or service bindings. The creation process may include assigning a unique workspace identifier and registering the workspace in an internal registry for lifecycle tracking and access management.

In an embodiment, the user may associate one or more agents with the workspace at the time of creation or through subsequent operations. The system binds the specified agents to the workspace context, allowing them to execute within the defined resource and policy boundaries. The workspace remains in an idle state until a task is assigned. Once a task is assigned, the system activates the runtime and exposes the workspace interfaces required for execution, logging, or communication. The user may query the state of the workspace, update its configuration, or terminate it when the associated tasks are complete.

In an embodiment, a user makes a request to install agents in the workspace (Operation 310). The request includes identifiers for each agent and may optionally include configuration parameters, such as initialization arguments, environment bindings, or proxy references. The system receives the request and verifies that the specified agents are available for deployment, that the workspace is in a valid state to receive new agents, and that resource constraints permit installation.

In an embodiment, the workspace fetches agent definitions for agent A and agent B from the marketplace (Operation 315). Agent definitions comprise executable code, dependency information, and a manifest describing runtime requirements and access policies. In an embodiment, the marketplace returns agent A and agent B to the workspace (Operation 320).

In an embodiment, the workspace installs agent A and agent B into an agent execution environment associated with the workspace (Operation 325). The system loads the agent components into the workspace, sets up the runtime environment according to the manifest specifications, and performs initialization procedures, such as injecting configuration data or verifying service connectivity. Upon successful setup, the agents are marked as installed within the workspace context and become available for execution or orchestration by other system components.

In an embodiment, the workspace informs the user that the workspace is ready (Operation 330). This signal may be triggered by internal checks confirming that the required components have been initialized, resource allocation is complete, and agent status is marked as installed and idle. The workspace registers its state as “ready” in a workspace status store or control plane registry accessible to system components and user interfaces.

In an embodiment, the user sends a request to the workspace to perform a business objective (Operation 335). A machine learning model may interpret the business objective to determine the agents that are required and the configured connections that are useful. Based on the machine learning model interpretation or other interpretation of the business objective, the discovery agent configures a context-aware objective associated with the workspace or a workflow within a workspace.

In an embodiment, the workspace initializes agent A with a workspace context derived from the business objective (Operation 340). The context may include, for example, available connections, configurations, and/or targets associated with the workspace or with one or more workflows associated with the workspace. The workspace also initializes agent B with the workspace context derived from the business objective (Operation 345).

In an embodiment, agent A and agent B complete tasks derived from the business objective (Operation 350). For example, a research agent and an editor agent may execute within a workspace and complete their assigned tasks. Each agent performs its designated function within the constraints of the workspace environment, using available system resources, predefined inputs, and permitted external services. Upon reaching task completion, each agent generates a result payload including output data, status indicators, and any relevant logs or metadata associated with the execution.

In an embodiment, the workspace issues a response to the user (Operation 355). Issuing a response may include transmitting result payloads through a notification mechanism configured at the time of task assignment. This may involve writing the results to a shared data location, emitting a structured message to a callback URL, or pushing notifications through a user interface or messaging system. The message to the user may include identifiers for the agent, completion status, output references, and timestamps. This allows the user to access the results, review execution summaries, and determine whether to trigger follow-up actions or terminate the workspace.

### 5. EXAMPLE EMBODIMENT B

A detailed example is described below for purposes of clarity. Components and/or operations described below should be understood as one specific example that may not be applicable to certain embodiments. Accordingly, components and/or operations described below should not be construed as limiting the scope of any of the claims.

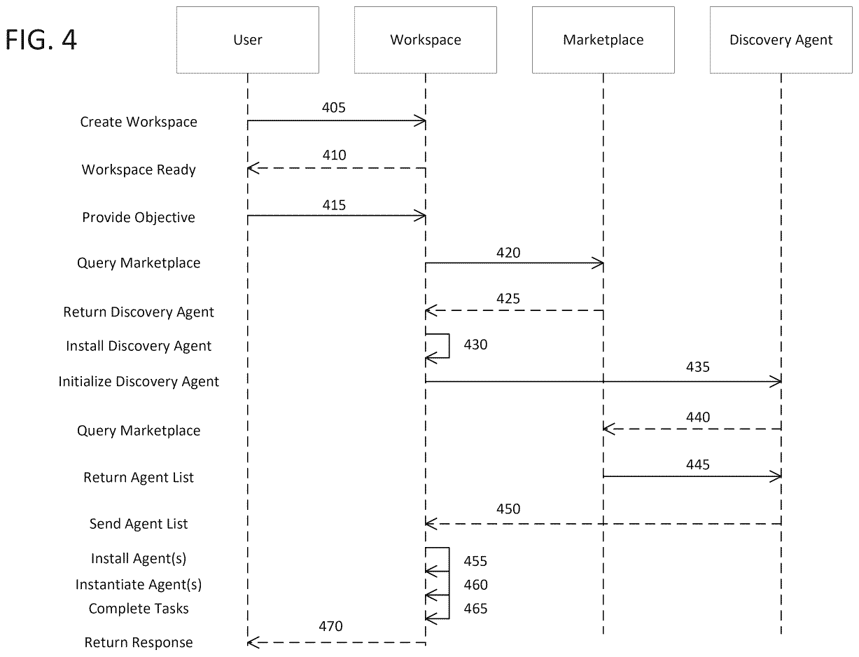

FIG. 4 illustrates an example set of operations for operating agents in a workspace in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, a user creates a workspace with a discovery agent running in the execution environment associated with the workspace (Operation 405). Creating a workspace includes submitting a request that specifies the desired characteristics of the workspace, such as runtime type, resource constraints, and associated execution context. The system receives the request and allocates a sandboxed environment that satisfies the provided parameters. The workspace is instantiated with isolated compute and memory resources, predefined environment variables, access policies, and optionally preconfigured storage mounts or service bindings. The creation process may include assigning a unique workspace identifier and registering the workspace in an internal registry for lifecycle tracking and access management.

In an embodiment, the workspace signals to the user that the workspace is ready (Operation 410). This signal may be triggered by internal checks confirming that required components have been initialized, resource allocation is complete, and agent status is marked as installed and idle. The workspace registers its state as “ready” in a workspace status store or control plane registry accessible to system components and user interfaces.

In an embodiment, the user provides a business objective to the workspace (Operation 415). A machine learning model may interpret the business objective to determine the agents that are required, and the configured connections that are useful.

In an embodiment, the workspace queries the marketplace to discover agents (Operation 420). In an embodiment, the marketplace returns agents for discovery (Operation 425). The discovery agent is configured to make requests to the marketplace. In an embodiment, the workspace installs the discovery agent in an agent execution environment associated with the workspace (Operation 430).

In an embodiment, the workspace initializes the discovery agent with a workspace context (Operation 435). In an embodiment, the discovery agent queries the marketplace for agents relevant to the workspace context (Operation 440). The discovery prepares the request by translating internal data structures or user-supplied input into a format that aligns with the expected request model for the agent marketplace. This translation process maps internal values to marketplace-recognized values, encodes search constraints or discovery criteria, and includes any required headers, tokens, or content types. The request is then transmitted to the agent marketplace endpoint, where it is parsed and routed to the appropriate handler for processing.

In an embodiment, the marketplace returns a list of relevant agents to the discovery agent (Operation 445). The response comprises structured data representing matching agents, including identifiers, display names, version information, supported target types, and any associated metadata, such as compatibility tags or required runtime environments. The list may be sorted or filtered based on the criteria specified in the request, such as agent type, resource type, task category, resource constraints, or user access level.

In an embodiment, the discovery agent provides, to the workspace, a list of agents relevant to the workspace context (Operation 450). For example, the system associates the context of available connections, configurations, and/or targets associated with the workspace or with one or more workflows associated with the workspace. Based on the context, the discovery agent may filter or sort the agents as well as provide suggestions with a confidence metric.

In an embodiment, the workspace installs one or more of the agents provided in operation 450 to an agent execution environment associated with the workspace (Operation 455). In an embodiment, agents are instantiated based on the business objective (Operation 460). In an embodiment, the installed agents complete the tasks (Operation 465). In an embodiment, the user receives a response from the workspace (Operation 470).

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### TRIGGERS

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### ACTIONS

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and inform whether to increase, decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

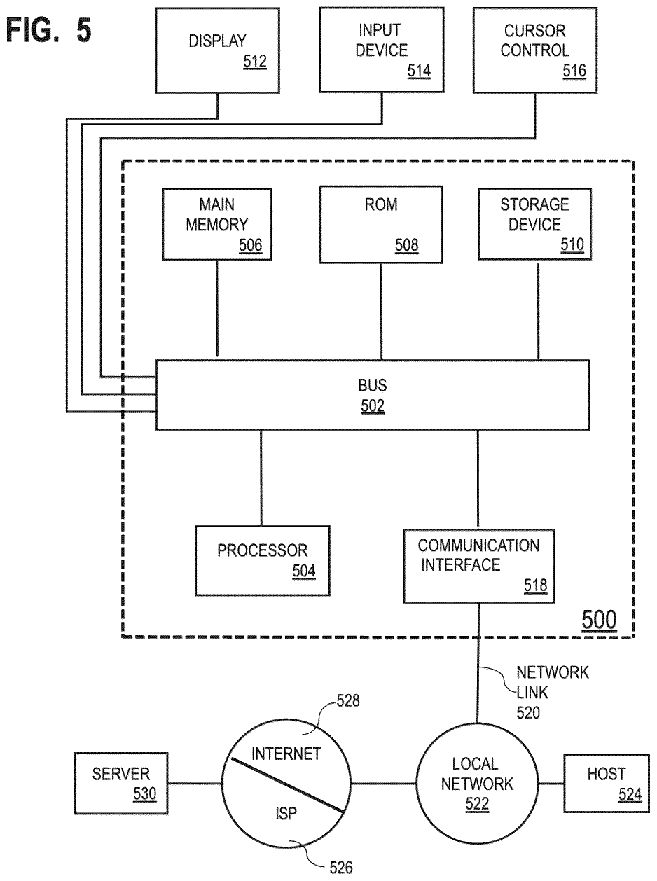

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
executing an agent management platform configured for selection and deployment of agents;
instantiating a first workspace, wherein the first workspace comprises a sandboxed agent execution environment associated with the agent management platform;
configuring the first workspace to facilitate access to one or more resources at least by storing a set of access parameters corresponding to each of the one or more resources;
deploying one or more agents in the first workspace;
transmitting, within the first workspace, an advertisement that includes a first set of access parameters corresponding to a first resource; and
based at least in part on the advertisement of the first set of access parameters, configuring a first agent of the one or more agents to access the first resource based on the first set of access parameters.

2. The one or more non-transitory computer readable media of claim 1, wherein the advertisement indicates that the first set of access parameters are associated with a particular agent type, and wherein the step of configuring the first agent is based at least in part on determining that the first agent is associated with the particular agent type.

3. The non-transitory media of claim 1, wherein the operations further comprise:
while executing the agent management platform, receiving a request for deployment of an agent into the first workspace;
wherein the request comprises:
a selection of an agent type from a plurality of agent types associated with the agent management platform; and
a function to be performed by the agent within the agent execution environment; and
wherein deploying the one or more agents in the first workspace comprises instantiating and deploying an agent of the agent type in the first workspace based on the request.

4. The non-transitory media of claim 3, wherein the agent uses agent-specific credentials corresponding to the agent to access the agent execution environment and perform the function within the agent execution environment.

5. The non-transitory media of claim 1, wherein the instructions further comprise:
after deploying the first agent, the first agent receiving the advertisement, wherein the set of access parameters includes a first parameter that indicates how to reach a connection proxy, and a second parameter that indicates a target type;
configuring the first agent to reach the connection proxy; and
the first agent making a first connection request to the connection proxy, wherein the first connection request indicates a first target type.

6. The non-transitory media of claim 5, wherein the instructions further comprise:
responsive to receiving the first connection request from the first agent, the connection proxy brokering a connection between the first agent and a first target associated with the first target type.

7. The non-transitory media of claim 6, wherein the instructions further comprise:
subsequent to the first connection request, the connection proxy determining that the first target type corresponds to a second target; and
responsive to receiving a second connection request from the first agent that indicates the first target type, brokering a connection between the first agent and the second target.

8. The non-transitory media of claim 1, wherein the instructions further comprise:
deploying a first discovery agent in the first workspace, wherein the first discovery agent corresponds to a first agent marketplace;
receiving, at the first discovery agent, an agent discovery request that indicates a first target type;
responsive to the agent discovery request, the first discovery agent selecting, from the first agent marketplace, a first agent associated with the first target type; and
deploying the first agent in the first workspace.

9. The non-transitory media of claim 8, wherein the instructions further comprise:
responsive to the agent discovery request, the first discovery agent selecting, from the first agent marketplace, a first set of one or more agents associated with the first target type;
wherein the first agent is one of the first set of one or more agents associated with the first target type;
presenting a list of the first set of one or more agents to a user; and
responsive to the user selecting the first agent from the list of the first set of one or more agents, deploying the first agent in the first workspace.

10. The non-transitory media of claim 9, wherein the agent discovery request further indicates a second target type, and the instructions further comprise:
responsive to the agent discovery request, the first discovery agent selecting, from the first agent marketplace, a second set of one or more agents associated with the second target type;
presenting a second list corresponding to the second set of one or more agents to the user; and
responsive to the user selecting a second agent from the second list, deploying the second agent in the first workspace.

11. The non-transitory media of claim 9, wherein the first agent is associated with a corresponding agent manifest that identifies one or more configured target types with which the first agent is able to interact, and the step of selecting the first agent comprises matching the first target type with the configured target type.

12. The non-transitory media of claim 8, wherein the instructions further comprise:
instantiating a second workspace;
configuring the second workspace to facilitate access to a second set of one or more resources at least by storing a set of access parameters corresponding to each of the one or more resources;
deploying the first agent in the first workspace;
transmitting, within the second workspace, an advertisement that includes a second set of access parameters corresponding to a second resource; and
based at least in part on the advertisement of the second set of access parameters, configuring the first agent to access the second resource based on the second set of access parameters.

13. The non-transitory media of claim 1, wherein the instructions further comprise:
configuring a context-aware objective corresponding to the first workspace;
prior to configuring the first agent to access the first resource, determining that the first agent corresponds to the context-aware objective;
subsequent to configuring the first agent to access the first resource, determining that the first agent does not correspond to the context-aware objective; and
responsive to determining that the first agent does not correspond to the context-aware objective, removing the first agent from the workspace.

14. The non-transitory media of claim 13, wherein the instructions further comprise:
subsequent to determining that the first agent does not correspond to the context-aware objective, determining that a second agent corresponds to the context-aware objective; and
responsive to determining that the second agent corresponds to the context-aware objective, deploying the second agent in the workspace.

15. The non-transitory media of claim 14, wherein determining that the first agent does not correspond to the context-aware objective comprises:
ingesting one or more agent activity log files that indicate agent activity within the agent management platform; and
identifying one or more agent activity entries for the second agent that correspond to the context-aware objective.

16. The non-transitory media of claim 1, wherein configuring a context-aware objective corresponding to the first workspace comprises:
receiving a natural language prompt;
using a machine learning model to extract, from the natural language prompt, a context and a business objective; and
storing the context and the business objective in a configuration associated with the first workspace.

17. The non-transitory media of claim 1, wherein the step of storing a set of access parameters corresponding to each of the one or more resources is performed while there are no agents deployed within the first workspace.

18. The non-transitory media of claim 1, wherein the instructions further comprise:
after deploying the first agent, the first agent receiving the advertisement, wherein the set of access parameters includes a first parameter that indicates a target type and a second parameter that identifies a target resource;
creating a mapping indicating a correlation between the first parameter and the second parameter; and
the first agent making a connection request to the target resource identified by the second parameter, wherein the connection request indicates a target type.

19. A method comprising:
executing an agent management platform configured for selection and deployment of agents;
instantiating a first workspace, wherein the first workspace comprises a sandboxed agent execution environment associated with the agent management platform;
configuring the first workspace to facilitate access to one or more resources at least by storing a set of access parameters corresponding to each of the one or more resources;
deploying one or more agents in the first workspace;
transmitting, within the first workspace, an advertisement that includes a first set of access parameters corresponding to a first resource; and
based at least in part on the advertisement of the first set of access parameters, configuring a first agent of the one or more agents to access the first resource based on the first set of access parameters;
wherein the method is performed by at least one device including a hardware processor.

20. A system comprising:
at least one device including a hardware processor;
the system being configured to perform operations comprising:
executing an agent management platform configured for selection and deployment of agents;
instantiating a first workspace, wherein the first workspace comprises a sandboxed agent execution environment associated with the agent management platform;
configuring the first workspace to facilitate access to one or more resources at least by storing a set of access parameters corresponding to each of the one or more resources;
deploying one or more agents in the first workspace;
transmitting, within the first workspace, an advertisement that includes a first set of access parameters corresponding to a first resource; and
based at least in part on the advertisement of the first set of access parameters, configuring a first agent of the one or more agents to access the first resource based on the first set of access parameters.
